(19) United States
(12) Patent Application Publication
(10) Pub. No.: US 2012/0207903 A1
(43) Pub. Date: Aug. 16, 2012

(54) Consumer Wine Additive

(76) Inventor: Edward Yavitz, Loves Park, IL (US)

(21) Appl. No.: 13/024,996

(22) Filed: Feb. 10, 2011

(51) Int. Cl. A23L 1/22; C12G 1/00

(52) U.S. Cl. 426/536; 426/592

(57) ABSTRACT

The present invention provides a method for a consumer to enhance the quality of an average glass or carafe of wine by placing an additive into the glass or carafe and allowing its ingredients to mix with the wine. The mixture of food grade chemicals and natural sweeteners improves the wine drinking experience in the major physical and sensory aspects that make for an above average wine. These include: a smoky oak flavor, improved sweetness of the fruit, a toasty or roasted coffee aroma and aftertaste, the hint of spices and scents such as leather, tobacco, nutmeg, basil, rosemary, earthiness. Beyond enhancing the taste of the wine, certain hygroscopic constituents of the present invention improve mouth feel of the treated wine and increase the length of the finish of the wine, the length of time the flavors linger on the palate. The method of the present invention allows a wine consumer to improve their sensory experience while drinking the treated wine. All of this is done without changing the basic underlying balance of acidity and fruit of the original wine. The pH is not disturbed with this additive which can be stored in individual plastic or foil pouches or containers intended to be carried in the pocket when dining out.

### BACKGROUND OF THE INVENTION

1. Field of the Invention

The present invention relates broadly to wine beverage additives to be used by a wine consumer in a bottle that has been opened or poured into a glass or carafe, for improving both the flavor and certain desirable physical characteristics of the wine. More specifically, the present invention relates to wine additives which improve the flavors and increase the length of finish of the wine.

2.Description of Prior Art

Wine is a popular drink around the world and is produced in vast amounts in almost every country. Unfortunately, only a small percentage of wine is considered outstanding by experts making it unattainable or unaffordable for the average person. The art of wine degustation has developed over the centuries at first in order to be sure to avoid a dangerous bottle, one that had spoiled. Today, it delineates the preferred attributes of the wine drinking experience. Considering the important physical and sensory aspects of the most expensive and desired wines of the world, it would be advantageous if a consumer could improve an average bottle of wine by adding a combination of ingredients to the bottle once it has been opened or to the glass or carafe once it has been poured. Through trial and error testing, the present invention claims a unique combination of chemical and food additives which serve to interact with the wine and with each other to improve the wine drinking experience.

As background, it is first necessary to review the universally agreed upon elements of the finest glass of wine; that is, what are the desirable aspects of rarer and more expensive wines? There are many aspects of wine, and each vintage and type has its nuances. There are some basic physical and sensory aspects of great wines that most experts can agree upon:
Oakiness or smokiness—Many wines have a smoky ‘oak’ flavor. The flavor is generally derived from the aging oak barrel or oak chips. The chemical most responsible for this flavor is vanillin. Oak wood is composed of several classes of complex chemical compounds, each of which contributes its own flavor or textural note to both red and white wines. The most familiar of these are vanilla flavors, sweet and toasty aromas, notes of tea, tobacco, saddle leather and an overall structural complexity of tannin that mingles with the tannin from the skin and seeds of the grapes (in the case of red wines).
Sweetness—The process of winemaking allows a certain amount of the natural sugars from the grapes to remain without being converted by yeasts to alcohol. So a sweetness, and sometimes a fruity taste remains from the amount of residual sugar. This fruitiness is described by specific fruits such as cassis or berries. The highest praise is to call a red wine a “fruit bomb”. White wines are often described as having flavors and scents of traces of exotic fruits such as pineapple. Red wines are appraised by the length of their “finish”, that is, how long the fruity flavors last in the mouth and on the tongue once the liquid has been swallowed.
Tannin or Acidity—A wine with more tannins would be described most of the time as dry. Tannin is the astringency from the seed and skin of the grape and is delivered to the wine during the maceration and initial holding time. Over years in the bottle, the tannins soften to balance with the sweetness of the fruit.
Mouth feel—This is the opposite of acidity or astringency. It gives the wine a feeling of softness and thickness or body inside the mouth. It actually adds weight and fullness to the wine, giving the illusion of swelling inside the mouth. It may well be due in part to the hygroscopic nature of the alcohol in the wine. This aspect of the greatest wines is often overlooked in degustation descriptions but is a critical aspect of the tasting experience and an important aspect of the present invention.

Adding flavorings to food and beverages is taught in numerous patents that give specific combinations of flavors for specific foods. For example, U.S. Pat. No. 5,380,540 (Yamanaka, et al.) describes the use of the additive of triose-reductone, hydroxymalon-dialdehyde or hydroxypyruvaldehyde in order to increase the saltiness or to modify the sourness of food. Neither of these tastes would enhance any wine. Bowen et al. in PCT/WO/1994/026868 describes a process for distilling oak wood flavors to be added as a flavoring to wine. This is intended to be carried out during the production of a wine, and is not practical for a retail consumer to perform on a single bottle. Likewise with the flavorings taught in U.S. Pat. No. 7,866,254 (Karasch et al.) and U.S. Pat. No. 5,102,675 (Howell et al.). While prior art may include one or more beverage flavorings, it does not combine them with a hygroscopic element in order to improve the physical characteristics of wine such as its mouth feel and finish. U.S. Pat. No. 5,849,346 (Hornak) describes the use of flavorings for use in a beverage additive but requires an alkaline solution to neutralize the acidity of the wine. The present invention recognizes that the basic balance between acidity and fruitiness of a given wine should not be altered and does not utilize acid-neutralizing methods or ingredients.

It should be noted that the additive embodied in the present invention is not a substitute for or a concentrate of a finished beverage product such as the beverage concentrate taught in U.S. Pat. No. 6,350,484 (Ault) or the drink mix formulation in U.S. Pat. No. 6,071,547 (Schechter). U.S. Pat. No. 6,132,788 (Zimlich, III) describes a method of creating a concentrated extract of a mature oak aged alcoholic beverage using a food grade solvent. This extract can be added to a low cost alcoholic beverage during its production to impart the taste of a more expensive mature oak aged alcoholic beverage. Its successful use in whiskey does not guarantee that it would be useful as an additive to wine, nor is it hygroscopic and therefore it does not improve texture and mouth feel as with the requisite hygroscopic ingredients in the present invention.

One approach to deliver mouthfeel is to use ingredients that increase the thickness (viscosity) of the beverage. However, increasing the viscosity of the beverage does not necessarily translate into an increase in desirable mouthfeel attributes. Mouthfeel is more of a sensory perception influenced by forces distinct from those that contribute to viscosity which give the perception of thickness. Hydrocolloid gums and water-soluble starches are typically used to increase beverage viscosity. Unfortunately, these create a slimy feeling when added to wine. Examples include U.S. Pat. No. 6,730,336 (Villagran, et al.) which uses a water-insoluble microparticulate component and a fat or oil component which cloud wine and therefore is not intended to be used with wine. Another example is U.S. Pat. No. 6,037,380 (Venables, et al.) which uses microcrystalline cellulose to increase viscosity. U.S. Pat. No. 7,182,968 (Gare) and U.S. Pat. No. 4,504,496 (Underberg, et al.) both use xylitol and fiber to improve viscosity in foods and beverages containing sugar and fat, which would rule out wine as a target since the flavor of fat is not desirable.

The present invention utilizes glycerol as a preferred additive to improve the mouthfeel of wine. While U.S. Pat. No. 4,514,422 (Yang) teaches the use of a mixture of sugar alcohol and glycerin flavorings, it is used only in combination with a chewing gum base for the prevention of dehydration and staling of the gum and is not anticipated for use as an additive to wine. Glycerol is included in a rehydrating sports drink in U.S. Pat. No. 6,485,764 (Robergs et al.) but it includes water, sodium and high levels of potassium for the purpose of replacing electrolytes in athletes. This combination would adversely alter the taste of wine. U.S. Pat. No. 4,840,812 (Tominaga) teaches the use of salts or glycerol as an osmotic agent which comes into contact with but is not intended to be mixed with wine. As an osmotic agent, separated and contained by a semi-permeable membrane, the glycerol reduces water and substances with unpleasant odors from the wine it is in contact with and is then removed from the wine. The inventors did not contemplate adding the glycerol to the wine for ingestion by the consumer in order to increase the wine's hygroscopic characteristics. Mixing glycerol with wine negates glycerol's osmotic properties and defeats the entire purpose of the Tominaga invention.

### SUMMARY OF THE INVENTION

The present invention is a partially miscible combination of ingredients contained in a disposable and portable container. Separately, each ingredient improves upon one of the natural attributes of fine wine but combined, they add to the balance and overall sensory experience of the consumer. The additives of the present invention may be provided in a number of product packaging formats well known to those skilled in the art of packaging. By way of example, but without limitation, suitable packaging includes plastic, foil, or multi-layered packets or pouches. One size would be appropriate for a single glass of wine and a larger size could be available for addition to an open bottle or decanter. In a preferred embodiment, a plastic container has a breakaway top which the user twists to break it off the main container, then empties the contents into an open bottle, glass or carafe of wine prior to ingestion. In combination with commercially available wine, this consumer additive to wine enhances the physical, aromatic and flavor attributes of the wine, raising an ordinary inexpensive wine to a level approaching more expensive and rarer wines.

### DETAILED DESCRIPTION OF THE PREFERRED EMBODIMENT

In one aspect, some of the ingredients of the present invention enhance the flavor and aroma of the wine without altering the acidity, viscosity or other physical characteristics of the beverage. The preferred flavor enhancing ingredients include one or more of the following:
Liquid smoke (0.001 to 10 percent of the additive by volume) which is the condensed solution of smoke derived from smoldering wood chips or sawdust from hickory, apple, pecan, mesquite woods or a combination of these woods. An example is the product made by Colgin company. This enhances the smokiness of the wine.
Vanillin (0.001 to 10 percent by volume), a volatile phenol which improves the aroma and sweetness.
Furfural, 2-furanmethanethiol or 2-furfurylthiol (0.01 to 10 percent by volume) imparting a toasty or roasted coffee aroma and aftertaste.
Geraniol, a terpinoid alcohol (0.001 to 10 percent by volume) to enhance the floral, tobacco, nutmeg, basil, rosemary, sage, cardamom aromas and flavors.
4-methylthio-butanol (0.001 to 10 percent by volume) to give an earthy aroma and flavor.

In another aspect of the present invention, it is understood that improving the flavor of wine alone is not enough to produce a superior wine-drinking experience. This requires an improvement in mouth feel and in the length of the finish or the time that the flavors linger on the palate after the wine has been swallowed. One or both of the following specific ingredients are needed to accomplish this by virtue of their hygroscopic attributes:
Glycerol, propane-1,2,3-triol (1.0 to 50 percent by volume) improves mouth feel and increases the length of the finish of the wine due to its hygroscopic action on the tongue and buccal mucosa. It also acts as a preservative against decomposition due to its antiseptic qualities.
Honey (1.0 to 50 percent by volume) serves a dual purpose to enhance the sweetness and to give a longer aftertaste to the wine due to the hygroscopic attributes of the levulose and colloidals that are natural honey components.

The combinations and concentrations of each of the aforementioned ingredients can be modified by those skilled in the art of blending flavors and wine tasting depending on the needs of specific wine types. For example, a white wine would not be enhanced with earthy notes so the use of 4-methylthio-butanol would not be recommended, yet that same ingredient would be essential for use in a merlot or cabernet sauvignon. On the other hand, a burnt toast finish to champagne is often desirable, so the concentration of Furfural would be increased in the additive packet designed for this type of wine. The following examples serve to illustrate this point.

### EXAMPLE 1

An additive for Champagne of 0.5 ml in a plastic dropper bottle containing:
Vanillin 10 percent concentration by volume;
Furfural, 2-furanmethanethiol or 2-furfurylthiol in a 10 percent concentration by volume;
Clover honey in a 40 percent concentration by volume;
Glycerol in 40 percent concentration by volume.

When the 0.5 ml or 10 drops of this combination of additives was placed in a flute of champagne and swirled for 30 seconds to mix, the resulting glass of wine had improved mouthfeel, a toastier finish and was fruitier than an untreated glass of the same wine.

### EXAMPLE 2

An additive for Merlot consisting of 0.5 ml of the following ingredients in a plastic dropper bottle:
Liquid Smoke 1 percent concentration by volume;
Vanillin 10 percent concentration by volume;
2-furfurylthiol 10 percent concentration by volume;
4-methylthio-butanol 9 percent concentration by volume;
Honey 50 percent concentration by volume
Water 20 percent concentration by volume

This was added to the glass of merlot and swirled for a minute. The aroma of tobacco and earthiness was enhanced as was the length of the finish.

The present invention allows for the modification of the concentration of each of the mentioned flavors or the addition of other flavors and volatile oils to be included in the additive to satisfy changing popular tastes as time goes on.

What is claimed is:

1. A method of improving the sensory experience of a wine consumer, comprising
An after-bottling wine beverage additive which includes both flavorings and hygroscopic constituents.

2. The wine beverage additive of claim 1 wherein the flavorings include one or more of Liquid smoke in a 0.001 to 5 percent concentration by volume;
Vanillin in a 0.001 to 10 percent concentration by volume;
Furfural, 2-furanmethanethiol or 2-furfurylthiol in a 0.01 to 10 percent concentration by volume;
Geraniol in a 0.001 to 10 percent concentration by volume;
4-methylthio-butanol in a 0.001 to 10 percent concentration by volume;

3. The wine beverage additive of claim 1 wherein the hygroscopic constituents include one or more of
Honey in a 1 to 50 percent concentration by volume;
Glycerol, propane-1,2,3-triol in a 1 to 50 percent concentration by volume.
